(19) United States
(12) Patent Application Publication
(10) Pub. No.: US 2013/0266315 A1
(43) Pub. Date: Oct. 10, 2013

(54) SYSTEMS AND METHODS FOR IMPLEMENTING OPTICAL MEDIA ACCESS CONTROL

(71) Applicants: David Markham Drury, Pittsburgh, PA (US); David Jeffrey Graham, Sewickley, PA (US); Stephen Francis Bachor, Munhall, PA (US); Sherry Lea Kratsas, Cranberry Township, PA (US); Daniel Michael Flynn, Mars, PA (US)

(72) Inventors: David Markham Drury, Pittsburgh, PA (US); David Jeffrey Graham, Sewickley, PA (US); Stephen Francis Bachor, Munhall, PA (US); Sherry Lea Kratsas, Cranberry Township, PA (US); Daniel Michael Flynn, Mars, PA (US)

(73) Assignee: ACCIPITER SYSTEMS, INC., Wexford, PA (US)

(21) Appl. No.: 13/439,529

(22) Filed: Apr. 4, 2012

(51) Int. Cl. H04J 14/02

(52) U.S. Cl. 398/48

(57) ABSTRACT

A method and systems for implementing an access control algorithm across an optical network are described. The network includes a plurality of switch port devices, each including a local control plane processor. The local control plane processors receive control information related to the plurality of switch port devices; determine destination devices to which each of the plurality of switch port devices can transmit data and availability to receive incoming bursts at the switch port devices; and determine a time during the transmission period when the data is to be transmitted to at least one destination. Optionally, a central control plane processor receives control information from the local control plane processors and determines a time during a transmission period when at least a portion of the data is to be transmitted from at least one of the switch port devices to a destination, thereby regulating traffic over the optical network.

### BACKGROUND

The disclosed embodiments generally relate to the fields of optical networks, data switching and data routing. More specifically, the disclosed embodiments generally relate to methods for implementing an optical control plane incorporating optical media access control (OMAC).

Recently, fast tunable lasers have inspired the invention of new and novel wavelength-division multiplexing (WDM) network architectures. In fiber-optic communications, wavelength-division multiplexing (WDM) is a technology that multiplexes multiple optical carrier signals on a single optical fiber by using different wavelengths of light to carry different signals. In this way, WDM allows for a multiplication in capacity.

A WDM system typically uses a multiplexer to join multiple optical carrier signals together at a transmitter and a demultiplexer at the receiver to split the multiplexed signal into its original optical carrier signals.

One exemplary type of high-capacity WDM network is an optical burst (OB) network. An OB network refers to a network constructed from a plurality of nodes and one or more switches. An OB network uses optical transmissions to send data bursts between a source node and one or more destination nodes. Examples of OB networks can be found in U.S. patent application Ser. No. 13/372,719 filed Feb. 14, 2012, and entitled “System Architecture for Optical Switch Using Wavelength Division Multiplexing,” the contents of which are hereby incorporated by reference.

An OB network removes layers of conventional infrastructure equipment associated with typical fiber-optic networks. Thus, power, cooling and packaging costs are dramatically reduced as a result of the reduction in physical infrastructure. In addition, an OB network is easily scalable and can benefit from increases in optical technologies for improved bandwidth over time. An OB network is inherently transparent to the nature of the bursts carried over it, and may be designed to carry Ethernet traffic by providing Ethernet interfaces to connected computer systems, PCI Express traffic through PCI Express interfaces, Fiber Channel through Fiber Channel interfaces, and so forth.

In an OB network, destination specific wavelengths are assigned to data bursts destined for remote devices in the network so that the bursts can be directed to their destinations over an optical core. However, as traffic increases and laser switching time decreases, there is a need for a more robust optical control plane for an OB network to optimize traffic and performance.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this document is to be construed as an admission that the embodiments described in this document are not entitled to antedate such disclosure by virtue of prior invention. As used in this document, the term “comprising” means “including, but not limited to.”

In one general respect, the embodiments disclose a method of controlling access in an optical burst network during a transmission period. The method includes receiving, by at least one first control plane processor, cumulative control information related to a plurality of switch port devices operably connected to the at least one first control plane processor; determining, by the at least one first control plane processor, at least the following based upon the cumulative control information: one or more destination devices to which each of the plurality of switch port devices can transmit data and availability to receive incoming optical bursts at each of the plurality of switch port devices; and determining, by the at least one first control plane processor, a time during the transmission period when at least a portion of the data is to be transmitted from at least one of the plurality of switch port devices to at least one of the one or more destinations.

In another general respect, the embodiments disclose an optical burst network including a plurality of operably connected switch port devices. Each of the switch port devices includes an associated local control plane processor configured to transmit first local control information related to an associated switch port device, receive at least second control information related to another switch port device, and determine a time during a transmission period when at least a portion of one or more data streams is to be transmitted from the associated switch port devices to at least one destination based upon the second control information. The first local information includes an indication of the one or more data streams to be transmitted from the associated switch port device, a destination for each of the one or more data streams, and availability of a receiver at the associated switch port device to receive incoming data bursts,

In another general respect, the embodiments disclose an optical burst network including a plurality of operably connected switch port devices, wherein each of the switch port devices comprises a local control plane processor configured to transmit local control information related to an associated switch port device and a central control processor operably connected to each of the plurality of switch port devices. The central control processor is configured to receive the local control information and combine the local control information into cumulative control information; determine at least the following based upon the cumulative control information: one or more destination devices to which each of the plurality of switch port devices can transmit data and availability to receive incoming optical bursts at each of the plurality of switch port devices; and determine a time during a transmission period when at least a portion of the data is to be transmitted from at least one of the plurality of switch port devices to at least one of the one or more destinations.

### BRIEF DESCRIPTION OF THE DRAWINGS

FIG. 1 illustrates an illustrative optical burst network according to an embodiment.

FIG. 2 illustrates a flow diagram of an illustrative process for transferring data through an optical burst network.

FIG. 3 illustrates an illustrative optical burst network using a distributed Optical Media Access Control algorithm.

FIG. 4 illustrates a flow diagram of an illustrative process for transferring data through an optical burst network using a distributed Optical Media Access Control algorithm, such as the network shown in FIG. 3.

FIG. 5 illustrates an illustrative optical burst network using a centralized Optical Media Access Control algorithm.

FIG. 6 illustrates a flow diagram of an illustrative process for transferring data through an optical burst network using a centralized Optical Media Access Control algorithm, such as the network shown in FIG. 5.

### DETAILED DESCRIPTION

The following terms shall have, for the purposes of this application, the respective meanings set forth below.

A “burst” refers to a sequence of bits of information transmitted by a node. A burst may include, but is not limited to, raw data, framed data, or data arranged into packets prior to transmission. A burst may be transmitted from one node to one or more destination nodes over a network.

A “node” refers to a system (e.g., processor-based, field programmable gate array (FPGA) based or memory-based) configured to transmit and/or receive information from one or more other nodes via a network. For example, a node may transmit to one or more destination nodes by varying the wavelength of its transmissions to match a wavelength at which its burst is switched to a specific destination node.

A “switch” refers to a network component that provides bridging and/or switching functionality between a plurality of nodes. A switch may have a plurality of inputs and a corresponding number of outputs. Each node may be operably connected to a switch via both an input fiber and an output fiber.

An “Optical Burst” (OB) network refers to a network constructed from a plurality of nodes and one or more switches. An OB network uses optical transmissions to send data bursts between a source node and one or more destination nodes.

An “end device” is a network component that exists at the edge of a network. End devices may be components that end users interact with to access the network, including, but not limited to, computers and workstations. An end device may also be a component that an end user does not directly interact with, including, but not limited to, application servers such as email servers and web servers. An end device may include one or more end device interfaces for operably connecting to the network.

A “switch port device” is a network component functioning as an entry and exit point for an OB network. A switch port device may be configured to receive data from an end device for transmission through the OB network, transmit data to an end device from the OB network, transfer information to or receive information from a control plane processor regarding data and switch port device status, and other similar functions. A switch port device may be physically integrated within an end device (e.g., a PCI Express network interface card). Alternatively, a switch port device may be a stand-alone unit (e.g., a top-of-rack fabric extender) or contained within an optical core (e.g., as a line card). Additional detail and examples related to switch port devices are shown in U.S. application Ser. No. 13/276,924, filed Oct. 19, 2011 and titled “Optical Interface Device for Wavelength Division Multiplexing Networks,” and U.S. application Ser. No. 13/276,977, filed Oct. 19, 2011 and titled “Switch with Optical Uplink for Implementing Wavelength Division Multiplexing Networks,” the content of each of which is hereby incorporated by reference in its entirety.

A “control plane processor” is a network component that receives information about data streams that are arriving at one or more switch port devices and/or from a management path. Based upon this information, a control plane processor grants permissions to one or more switch port devices to transmit specific bursts over an optical core at a specific time or times. A control plane processor may exist as a singular centralized processor, a distributed set of processors, or a combination of centralized and distributed processors. Additional detail and examples related to control plane processors is shown in U.S. application Ser. No. 13/276,805, filed Oct. 19, 2011 and titled “Optical Switch for Networks Using Wavelength Division Multiplexing,” the content of which is hereby incorporated by reference in its entirety.

In the present disclosure, examples of an Optical Media Access Control (OMAC) algorithms are discussed. The OMAC algorithms may be used to control an optical control plane such that OB WDM-based network performance is optimized with respect to contention, congestion, fairness, latency and quality of service by controlling access to the network and optical core.

In an OB WDM-based network, each destination device is accessed by a unique wavelength within the network. The OMAC algorithm may be configured to determine various transmission needs of data sources by determining the type of data a device has to transmit and the wavelength on which the device should transmit. The OMAC algorithm may also be configured to signal or otherwise indicate when a data source can transmit so that collisions of bursts from multiple sources destined for the same destination are avoided. The OMAC algorithm, running on one or more devices, may transfer control information to and receive control information from other devices in the network via an optical control channel that operates separately from the optical data plane.

In order to make appropriate destination assignments, the OMAC algorithm may evaluate various aspects of the traffic in the network. Varying levels of traffic priorities may be supported such that higher-priority traffic is guaranteed pre-allocated amounts of bandwidth while lower-priority traffic is not. Additionally, bandwidth allocation fairness may be supported so that access to a congested destination node is allocated in proportion to the overall volume of traffic each node has to that destination.

Similarly, anti-starvation may be supported in order to prevent sources with higher-priority traffic from consuming all available bandwidth and, therefore, starving sources with lower-priority traffic bandwidth requirements. For example, a certain percentage of overall bandwidth may be dedicated to lower-priority traffic.

The OMAC algorithm may be implemented as logic implemented in one or more control plane processors. A control plane processor is composed of logic for computation and queuing (such as an application-specific integrated circuit (ASIC), a field programmable gate array (FPGA), a microprocessor, or other similar computational logic component). The control plane processor may include both electrical and optical ports for communication between switch port devices and other control plane processors.

In various embodiments, the OMAC algorithm makes use of separate and parallel control plane processors with respect to the data plane, thereby resulting in a distinct data plane and control plane. This arrangement results in the OMAC algorithm, and the associated control plane processors, to dynamically determine the data flow over the data plane, resulting in a quick out-of-band scheduling and routing control plane.

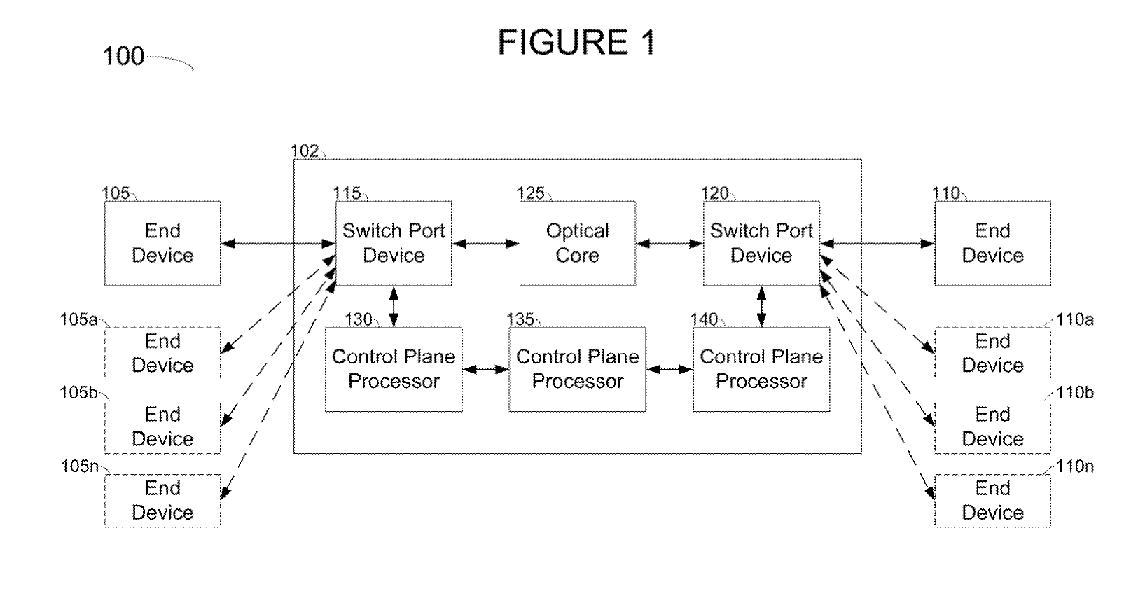

FIG. 1 shows an illustrative OB network 100 including an exemplary architecture for a switch 102. The switch 102 may be operably connected to a first set of end devices 105, 105a, 105b, . . . , 105n, and a second set of end devices 110, 110a, 110b, . . . , 110n.

Each of the end devices 105, 105a, 105b, . . . , 105n and 110, 110a, 110b, . . . , 110n may be operably connected to one of switch port device 115 and switch port device 120 respectively. Each switch port device 115 and 120 may be configured to receive incoming data from an end device, determine the destination of the data, and modulate the data into a burst of the appropriate wavelength or wavelengths such that the burst reaches the intended destination switch port device(s), where the burst is reformatted into data for transmission to the appropriate end device(s).

Each of switch port devices 115 and 120 may be operably connected to an optical core 125 and one or more control plane processors 130, 135 and 140. The optical core 125, in combination with the control plane processors 130, 135 and 140, may be configured to switch and direct data bursts based upon their wavelength. An example of an optical core is shown in U.S. patent application Ser. No. 13/035,045, filed Feb. 25, 2011 and titled “Optical Switch for Implementing Wave Division Multiplexing Networks,” the content of which is hereby incorporated by reference in its entirety. The control plane processors 130, 135 and 140 may be configured to control data flow from the switch port devices 115 and 120 to the optical core 125. The control plane processors 130, 135 and 140 may schedule transmissions over the optical core 125 such that only one burst is being sent to a destination at one time, thereby eliminating the chances of a burst being lost during transmission.

It should be noted that three control plane processors 130, 135 and 140 are shown by way of example only. In an alternative embodiment, a single control plane processor may by used to control data flow through the optical core. Alternatively, each of switch port devices 115 and 120 may have integrated control plane processors. The number of control plane processors may be determined by the layout of the OB network as well as the amount of traffic and related information to be processed, and thus may vary depending on the application and design of the network.

The optical core 125 may be operably connected to switch port device 120, and thus to end devices 110, 110a, 110b, . . . , 110n. This arrangement provides an efficient solution for delivering data across an optical core (e.g., from end device 105 to end device 110) while maintaining low latency and a high quality of service resulting from the integration of the control plane, resulting in no blocking, no data collisions and no loss. The arrangement takes advantage of the inherent strengths of optical technology for high-speed data throughput as well as the inherent strengths of silicon for logical operations and queuing.

It should be noted that the arrangement and architecture of OB network as shown in FIG. 1 is shown by way of example only. For example, the placement of the switch port devices 115 and 120 are shown by way of example only. In an alternative embodiment, the switch port devices may be integrated in the end devices as a network interface card (NIC) such as a PCI Express NIC. Similarly, the switch port devices 115 and 120 may be a stand-alone unit such as a top-of-rack fabric extender on a server rack. The switch port devices 115 and 120 may also be integrated in the optical core itself, for example, as a line card.

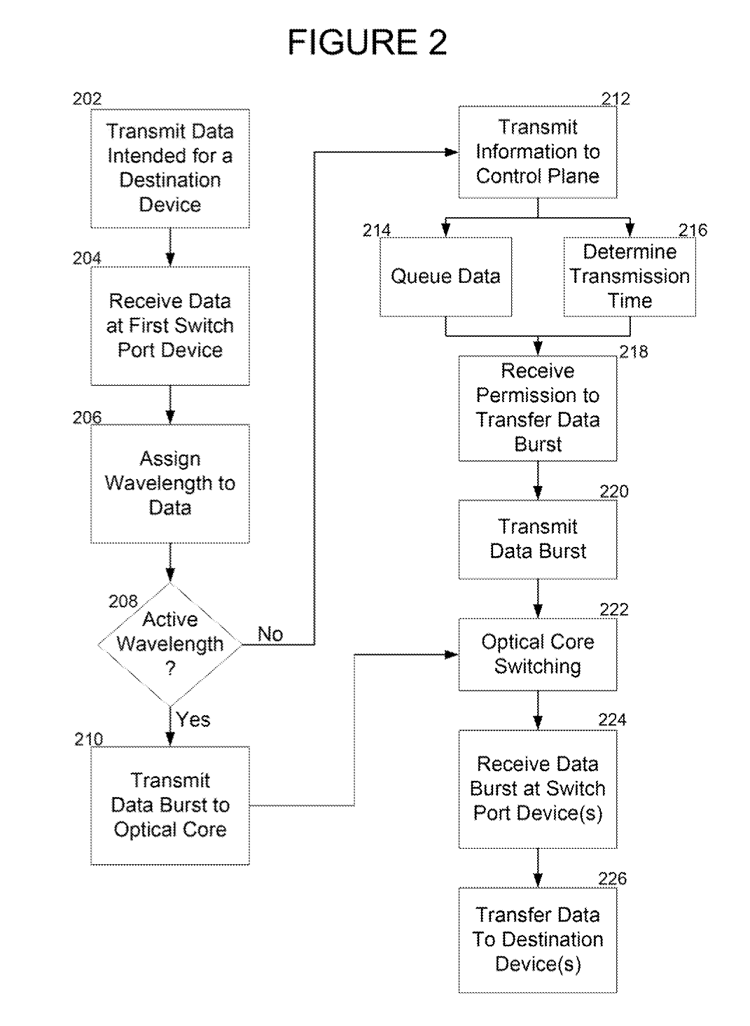

FIG. 2 shows an illustrative process for transferring data through an exemplary OB network, such as OB network 100, as shown in FIG. 1. An end device may transmit 202 data intended for a destination device to a switch port device. For example, the end device may transmit a data stream via a wired connection to the switch port device. The data stream may include the data intended for the destination device as well as addressing information indicating the destination device. The switch port device may receive 204 the data and determine the destination of the data from information contained therein. Based upon the destination of the data, the switch port device may assign 206 a wavelength to the data such that the data is correctly switched through the optical core to one or more appropriate switch port devices for transferring to the destination device(s). Alternatively, the assignment 206 of the wavelength may be based upon other aspects of the data or through management configuration information.

The switch port device may determine 208 whether the assigned 206 wavelength is an active wavelength. For example, the switch port device may determine 208 whether the assigned 206 wavelength has data bursts that are currently being sent via that wavelength through the optical core. If the switch port device determines 208 that the wavelength is an active wavelength, the switch port device may transmit 210 the data burst to the optical core. Otherwise, the switch port device may transmit 212 information related to the data to the control plane and queue 214 the data until the control plane responds with scheduling information related to the transmission of the data through the optical core. The control plane may receive the information related to the data and determine 216 a specific transmission time for the switch port device to transmit the data to the optical core. The specific transmission time may be based upon the current level of traffic passing through the optical core, the next free time period for transmitting a data burst via the assigned 206 wavelength, and other information related to the present traffic being passed through the optical core. This specific transmission time ensures that no other switch port devices will attempt to transfer through the optical core to the same end device at the same time, thus eliminating collisions within the optical core. The control plane may also select a specific transmission time such that any existing quality of service parameters guaranteed for that data will be met.

After a period of time, the switch port device may receive 218 permission from the control plane to transfer the data burst to the optical core via the specific scheduling information. In response to receiving 218 such permission, the switch port device may transmit 220 the data burst to the optical core. Transmitting 220 may include modulating the data to the assigned 206 wavelength and transmitting the data burst through the optical core.

Once the switch port device transmits 210, 220 the data burst to the optical core, the optical core may switch 222 the data based upon the wavelength of the optical burst. As discussed above, the optical core may be designed such that any incoming data bursts are switched to an appropriate output based upon the wavelength of the optical burst. One or more destination switch port devices may receive 224 the switched 222 data burst, determine the destination end device(s), reformat the data burst, and transfer 226 the data to the destination device(s). Prior to transferring 226 the data to the destination device(s), the one or more destination switch port devices may perform various functions on the data such as error checks, timing corrections, error corrections, data reassembly, burst mode clock and data recovery, and other similar functions. The one or more destination switch port devices may also transmit an acknowledgement to the control plane, indicating the data burst was received at the one or more switch port devices.

In order to schedule and direct the bursts appropriately, an OMAC algorithm may be implemented in the control plane. The OMAC algorithm may be implemented in a variety of ways. Two specific methods, a distributed method and a centralized method, will be discussed herein in detail. However, it should be noted that these methods are shown by way of example only, and additional or alternate methods may be used.

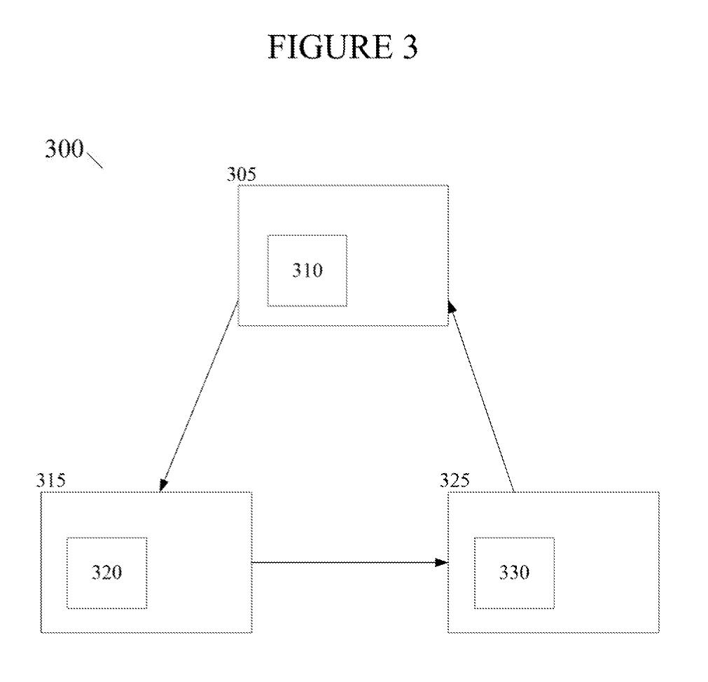

FIG. 3 shows an illustrative distributed OMAC algorithm implementation. OB network 300 includes switch port devices 305, 315 and 325. Each of the switch port devices 305, 315 and 325 includes an equivalent integrated control plane processor 310, 320 and 330 respectively. It should be noted that while the control plane processors 310, 320 and 330 are shown as integrated in switch port device 305, 315 and 325, control plane processors may be integrated into individual end devices as well.

Each of control plane processors 310, 320 and 330 may send control information, including its associated device's current transmission needs and availability to receive data bursts, to all other control plane processors in the network via, for example, a ring configuration as shown in FIG. 3.

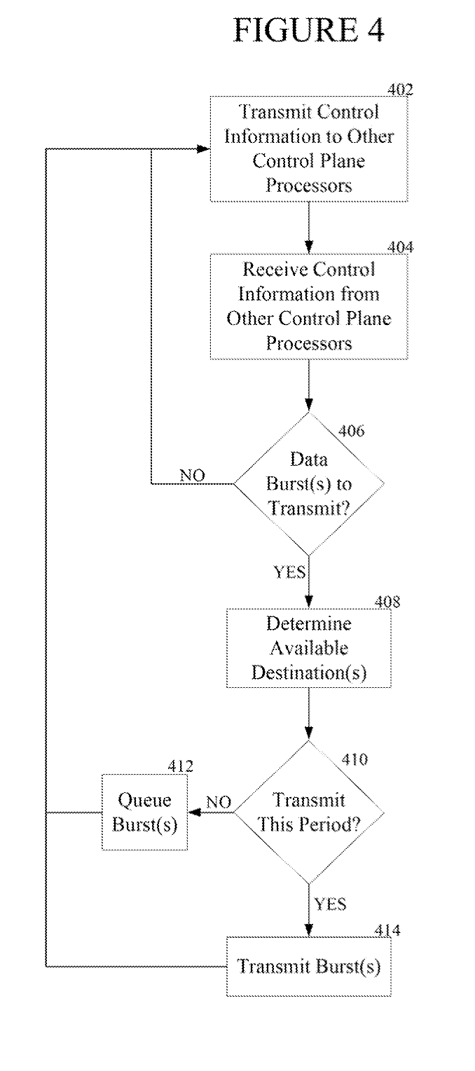

FIG. 4 shows an illustrative process for implementing an OMAC algorithm in a distributed environment such as network 300. The process as shown in FIG. 4 is for a single control plane processor (e.g., control plane processor 310), but may be repeated at each control plane processor in the network. Additionally, the process as shown in FIG. 4 illustrates a single transmission period. Depending on the capabilities of the network, the transmission period may be a specific length of time, e.g., 7 microseconds. For transmitting bursts, the transmission period may be single slots or divided into multiple microslots. For example, each transmission period may be divided into 100 nanosecond micro slots for transmitting individual bursts.

At the beginning of the transmission period, the control plane processor may transmit 402 its control information to the other control plane processors. The control information may include the current transmission needs of the device associated with the control plane processor as well as its ability to receive data bursts. The control plane processor may also receive 404 control information from the other control plane processors in the network. If the device associated with the control plane processor has 406 bursts to transmit, the control plane processor may determine 408 which destination(s) are available to receive transmitted bursts. Otherwise, the control plane processor may hold bursts until the next transmission period.

The availability of a destination may be determined 408 based upon both the advertised availability of the destination (as contained in its broadcast control information) as well as a determination as to whether another control plane processor has claimed the destination for receipt of its associated switch port device's burst(s). If the control plane processor determines 410 that it will not be able to transmit its associated burst(s) during the transmission period, the bursts are queued 412 and the process repeats at the next transmission period.

If the control plane processor determines 410 that it will be able to transmit its associated burst(s) during the current transmission period, the control plane process instructs its associated switch port device to transmit 414 the burst(s) during the transmission period. The process as shown in FIG. 4 may then repeat during the next transmission period.

In a distributed implementation, each control plane processor may operate in an equivalent role since each control plane processor has an identical instantiation of the OMAC algorithm. One exception may be that some specific functions of the OMAC algorithm may include one device serving in a master role. A master device may manage the synchronization of data transmissions across the network in order to avoid collisions between data streams. The master device may also serve to delineate timeframes when collection of control information ends for an upcoming transmission period and when the next period of control information gathering begins. In a distributed implementation, the master role may give a master device the first claim of a destination for a transmission period. In order to support fairness among all the switch port devices, the role of master may rotate to a control plane processor on a new switch port device at the end of each transmission period. In this manner, all control plane processors are equivalent in that they all have the ability to perform master processing. However, at any given point, only one device serves the master role.

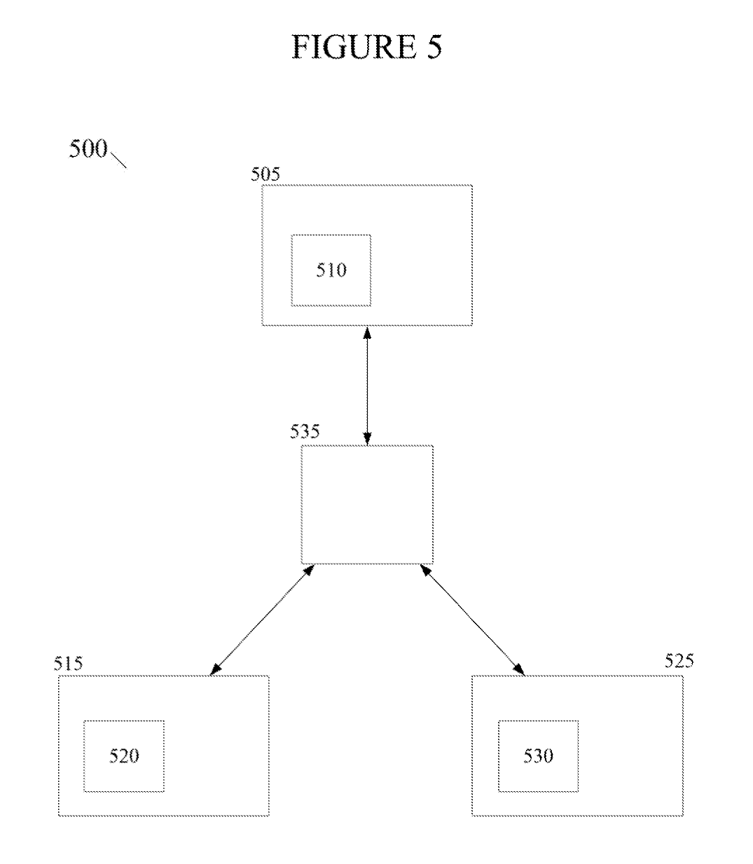

FIG. 5 shows an illustrative centralized OMAC algorithm implementation. OB network 500 includes switch port devices 505, 515 and 525. Each of the switch port devices 505, 515 and 525 includes an integrated local control plane processor 510, 520 and 530 respectively. It should be noted that while the local control plane processors 510, 520 and 530 are shown as integrated in switch port device 505, 515 and 525, control plane processors may be integrated into individual end devices as well.

Each of the switch port devices 505, 515 and 525 may be operably connected to a central control plane processor 535 such that local control plane processors 510, 520 and 530 may communicate with the central control plane processor. Each of the local control plane processors 510, 520 and 530 may send control information, including its associated device's current transmission needs and availability to receive data bursts, to the central control plane processor 535. The central control plane processor 535 may collect the control information and, based upon the collected control plane information, inform each individual device to which destination they may transmit during the transmission period.

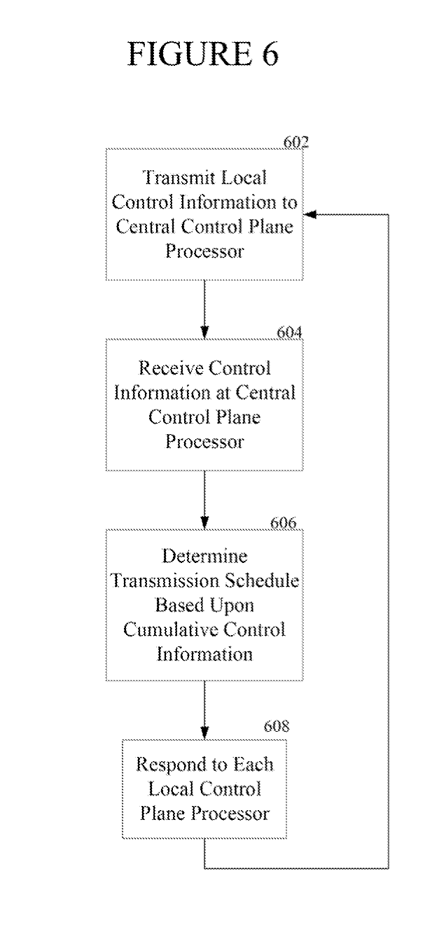

FIG. 6 shows an illustrative process for implementing an OMAC algorithm in a distributed environment such as network 500. The process as shown in FIG. 6 illustrates a single transmission period. As data arrives for transmission by the switch port devices through the optical core, the local control plane processors may transmit 602 its associated control information to the central control plane processor. The associated control information may include destinations to which the switch port devices are requesting access, the priority level of the data to be transmitted, amount of data to transmit and other related information. Additionally, the associated control information may include information related to the status of the receiver of the switch port device and whether the receiver is currently available to receive incoming bursts.

The central control plane processor may receive 604 the cumulative control information and may, based upon the cumulative control information, determine 606 a transmission schedule for the transmission period. The transmission schedule may be based upon the priority levels of data to be transmitted, availability of devices to receive incoming bursts, and other aspects, such as bandwidth allocation fairness. The central control plane processor may respond 608 to each local control plane processor with a grant of destination, if any, to which the device associated with a local control plane processor may transmit. The process as shown in FIG. 6 may repeat for each transmission period.

Unlike the distributed implementation, in the centralized implementation each control plane processor is not equivalent. The central control plane processor includes added functionality over the local control plane processors. The central control plane processor may be the sole master device for delineating transmission periods and managing fairness of access among the switch port devices. Additionally, in the centralized implementation, network resiliency is increased. In the event that an end device or switch port device is removed from the network, or otherwise becomes inoperable, little or no network downtime results. Similarly, the centralized implementation provides access latency that is independent of the number of switch port devices in the network, thereby allowing the network to scale upward in size with little impact on performance.

As outlined above, the OMAC algorithm has several key functions. The OMAC algorithm may be implemented such that it may determine data transmission needs for all switch port devices for a given timeframe, including the amount, priority and target destination of data to be transmitted. The OMAC algorithm may also: compare and prioritize data transmission needs between switch port devices; determine receiver availability at each switch port device; determine destination assignments for switch port devices based upon network-wide data transmission needs, pre-allocated bandwidth for high-priority data streams, and receive capabilities; indicate start of transmission times to switch port devices such that no data collisions occur; indicate start and/or stop times for collecting control information from switch port devices to allow for determination of destination assignments to occur; and coordinate management plan traffic during idle time between control messages. As also shown above, the way in which these functions are distributed among control plane processors in a network may vary based upon the way the network is specifically configured.

It should be noted that the control plane as discussed above in reference to FIGS. 1, 3 and 5 may operate on separate wavelengths from the data plane while sharing common optic fibers. Alternatively, the control plane may operate with separate optic fibers from the data plane or operate on a completely separate communication medium such as copper wire. If on fiber, the control plane signals may be in parallel with data plane signals or in-band with data plane signals on different time allocations.

It should also be noted that the switch as shown in FIG. 1 may be modified accordingly based upon the requirements of a network that the switches are integrated into. It should also be noted that while the disclosed embodiments refer to switching Ethernet frames, the switches may also carry alternate and/or additional networking protocols. For example, a switch, such as switch 102, may be integrated into an InfiniB and network or other computer cluster protocols, a Fiber Channel or other storage protocol (e.g., iSCSI) network, an Asynchronous Transfer Mode network, or another similar switched fabric network protocol configured to transfer data between nodes.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the disclosed embodiments.

What is claimed is:

1. A method of controlling access in an optical burst network during a transmission period, the method comprising:
receiving, by at least one first control plane processor, cumulative control information related to a plurality of switch port devices operably connected to the at least one first control plane processor;
determining, by the at least one first control plane processor, at least the following based upon the cumulative control information:
one or more destination devices to which each of the plurality of switch port devices can transmit data, and
availability to receive incoming optical bursts at each of the plurality of switch port devices; and
determining, by the at least one first control plane processor, a time during the transmission period when at least a portion of the data is to be transmitted from at least one of the plurality of switch port devices to at least one of the one or more destinations.

2. The method of claim 1, further comprising:
determining, by a local control plane processor at each of the plurality of switch port devices, control information specific to a switch port device associated with the local control plane processor; and
transmitting, by the local control plane processor, the control information to at least one first control plane processor.

3. The method of claim 2, wherein the control information comprises:
an indication of one or more data streams to be transmitted from the switch port device associated with the local control plane processor;
destinations for each of the one or more data streams to be transmitted from the switch port device associated with the local control plane processor; and
availability of a receiver at the switch port device associated with the local control plane processor to receive incoming data bursts.

4. The method of claim 2, wherein the cumulative control information comprises control information received from a local control plane processor at each of the plurality of switch port devices.

5. The method of claim 2, wherein the cumulative control information comprises control information received from management configuration information.

6. The method of claim 1, wherein determining a time during the transmission period when at least a portion of the data is to be transmitted comprises determining a time during the transmission period when at least a portion of the data is to be transmitted according to an optical media access control (OMAC) algorithm.

7. The method of claim 1, wherein the cumulative control information further comprises one or more priority levels for the data to be transmitted by each of the plurality of switch port devices.

8. The method of claim 1, wherein the cumulative control information further comprises guaranteed pre-allocated amounts of bandwidth for the data to be transmitted by each of the plurality of switch port devices.

9. The method of claim 1, wherein the cumulative control information further comprises bandwidth allocation fairness for the data to be transmitted by each of the plurality of switch port devices.

10. An optical burst network comprising:
a plurality of operably connected switch port devices, wherein each of the switch port devices comprises an associated local control plane processor configured to:
transmit first local control information related to an associated switch port device, the first local information comprising:
an indication of one or more data streams to be transmitted from the associated switch port device,
a destination for each of the one or more data streams, and
availability of a receiver at the associated switch port device to receive incoming data bursts,
receive at least second control information related to another switch port device, and
determine a time during a transmission period when at least a portion of the one or more data streams is to be transmitted from the associated switch port devices to at least one destination based upon the second control information.

11. The optical burst network of claim 10, wherein at least one local control plane processor is further configured to function as a master device in the optical burst network during the transmission period.

12. The optical burst network of claim 11, wherein the master device is further configured to manage synchronization of data transmissions across the optical burst network.

13. The optical burst network of claim 12, wherein the master device is further configured to delineate timeframes when collection of control information ends for an upcoming transmission period and when a period of control information gathering begins for another transmission period.

14. An optical burst network comprising:
a plurality of operably connected switch port devices, wherein each of the switch port devices comprises a local control plane processor configured to transmit local control information related to an associated switch port device; and
a central control processor operably connected to each of the plurality of switch port devices and configured to:
receive the local control information and combine the local control information into cumulative control information,
determine at least the following based upon the cumulative control information:
one or more destination devices to which each of the plurality of switch port devices can transmit data, and
availability to receive incoming optical bursts at each of the plurality of switch port devices, and
determine a time during a transmission period when at least a portion of the data is to be transmitted from at least one of the plurality of switch port devices to at least one of the one or more destinations.

15. The optical burst network of claim 14, wherein the local control information comprises:
an indication of one or more data streams to be transmitted;
destinations for each of the one or more data streams to be transmitted; and
availability of a receiver to receive incoming data bursts,
wherein the central control plane processor is further configured to determine a time during the transmission period when at least a portion of the data is to be transmitted according to an optical media access control (OMAC) algorithm.

16. The optical burst network of claim 14, wherein the cumulative control information further comprises one or more priority levels for the data to be transmitted.

17. The optical burst network of claim 14, wherein the cumulative control information further comprises guaranteed pre-allocated amounts of bandwidth for the data to be transmitted by each of the plurality of switch port devices.

18. The optical burst network of claim 14, wherein the cumulative control information further comprises bandwidth allocation fairness for the data to be transmitted by each of the plurality of switch port devices.

19. The optical burst network of claim 14, wherein the central control processor is further configured to manage synchronization of data transmissions across the optical burst network.

20. The optical burst network of claim 19, wherein the central control processor is further configured to delineate timeframes when collection of local control information ends for an upcoming transmission period and when a period of local control information gathering begins for another transmission period.
